(19) United States
(12) Patent Application Publication
(10) Pub. No.: US 2013/0290458 A1
(43) Pub. Date: Oct. 31, 2013

(54) CONTEXTUAL PEER BASED GUIDANCE SYSTEMS AND METHODS

(71) Applicants: Margaret E. Morris, Portland, OR (US); Richard P. Crawford, Davis, CA (US)

(72) Inventors: Margaret E. Morris, Portland, OR (US); Richard P. Crawford, Davis, CA (US)

(21) Appl. No.: 13/994,718

(22) PCT Filed: Apr. 30, 2012
(86) PCT No.: PCT/US12/35873

§ 371 Date: Jun. 15, 2013

(51) Int. Cl. H04L 12/58

(52) U.S. Cl. CPC H04L 51/00
USPC 709/206

(57) ABSTRACT

An embodiment includes a mobile computing device determining user profile elements and user goals for a user; determining user activity levels corresponding to the user goals; determining peer group activity levels corresponding to the user profile elements, user goals, and user activity levels; determining a peer group activity level exceeds a user activity level; sensing an environmental condition corresponding to the user's current environment; and communicating a message to the user, which corresponds to a peer group activity, based on (a) determining a peer group activity level exceeds a user activity level, and (b) the sensed environmental condition. Other embodiments are described herein.

### BACKGROUND

People are becoming more resourceful in the ways they use computing devices, such as mobile computing devices (e.g., Smartphones, tablets, notebooks, netbooks, personal digital assistants, and the like), to take care of themselves. This may be due in part to the rise in chronic disease, decreased access to clinical care, and increasing innovation in mobile technology. Phones and other mobile devices, along with their applications, hold promise for promoting health and associated lifestyle changes. Always at people's sides, these devices are trusted allies that “know” more about an individual's lifestyle than his or her clinicians. They are also portals into the movements, such as participatory medicine, in which people track, analyze, and share data typically managed by clinicians or businesses.

However, to have a significant impact health messaging on computing devices should engage people emotionally and motivate sustained lifestyle change. Many of the behavioral shifts that improve health outcomes—such as consuming less, exercising more, or weighing oneself daily—are relatively simple. The challenge lies in persuading people to initiate and sustain changes that fly in the face of habit, culture, convenience, and immediate gratification.

### BRIEF DESCRIPTION OF THE DRAWINGS

Features and advantages of embodiments of the present invention will become apparent from the appended claims, the following detailed description of one or more example embodiments, and the corresponding figures, in which:

FIG. 1 includes a flow chart for a method in an embodiment of the invention.

FIG. 2 includes a flow chart for a method in an embodiment of the invention.

FIG. 3 includes a flow chart for a method in an embodiment of the invention.

FIG. 4 includes a system for use with various embodiments of the invention.

### DETAILED DESCRIPTION

In the following description, numerous specific details are set forth but embodiments of the invention may be practiced without these specific details. Well-known circuits, structures and techniques have not been shown in detail to avoid obscuring an understanding of this description. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Connected” may indicate elements are in direct physical or electrical contact with each other and “coupled” may indicate elements co-operate or interact with each other, but they may or may not be in direct physical or electrical contact. Also, while similar or same numbers may be used to designate same or similar parts in different figures, doing so does not mean all figures including similar or same numbers constitute a single or same embodiment.

To drive lifestyle change, an embodiment uses health messaging to remind people of previously expressed self-ideals. People generally try to avoid dissonance between their behavior and values. It is also worth noting that people will give socially desirable responses when asked about their values and intentions, and later will feel driven to act consistently. This tendency to follow through on previously articulated intentions can be applied in a variety of ways to influence exercise and diet.

An embodiment may appeal to self-ideals through positive characterization. When people are ascribed character strengths, they are more likely to behave consistently. For example, those told “You are characterized as an above-average citizen likely to vote and participate in political events” are more likely to vote than people who do not receive this message. By extension, technologies can draw personal data to formulate characterizations such as “People like you, who are highly motivated and curious, enjoy learning new forms of exercise, developing new areas of expertise, and keeping fit.”

The very close relationships that people have with their devices allow embodiments to enable meaningful health coaching. The closer the bond one feels to a therapist, the more successful therapy will be. A collaborative alliance, fostered through empathy, co-investigation, and joint problem solving in therapy, can also be developed with a technology that interacts collaboratively.

Also, an embodiment allows the device/user therapeutic alliance to evolve over time by continuing to learn about the user and tailor feedback accordingly.

When it comes to important personal transitions, it is often difficult to know the desired destination or even how to frame a question: We may simply have an idea we want more novelty, more fun, or stronger relationships. Embodiments listen for goals over time, challenge users when their immediate requests run counter to the goals, and steer the users in the right direction.

Technologies know a tremendous amount about us and others. This knowledge, which now guides web searches, on-line retail purchases, and other consumer profiling, also drives healthful change in various embodiments. For example, in one embodiment personal data is used to reference peer groups who engage in healthful habits. The most relevant and specific peer group is identified for such referencing. Social comparison is then used to influence behavior. For example, to curtail substance abuse an embodiment may inform college students who drink heavily about the lower average consumption of their peers, using feedback such as “You drink a six-pack every Friday and Saturday; most men your age have only two drinks a week”. Similarly, an embodiment may inform hotel guests about the pro-environmental behavior of other guests. Those who read that most other guests who stayed in the same hotel room reused their towels for their three-day stay are more likely to do so themselves than those who read another environmental plea without this comparison.

An embodiment communicates messages to a user that are accurate references to desirable behavior. Such a normative appeal invites the user to join a desirable trend. Data mining, social networking applications, and mobile technologies are collectively used for powerful, timely communications that help the user achieve a goal.

Embodiments may communicate with a user via detailed narratives or videos depicting the successful steps others have taken can provide role modeling and thereby foster self-efficacy. The user can then learn from others' struggles. These scenarios are sourced from a video library concerning peer role modeling or from mining on-line social media video portals or repositories based on the patient's health concerns and demographics.

Embodiments may sense a user's context and communicate a message to the user based on the sensed context. For example, an embodiment delivers messages (e.g., a reminder) close in time and place of the target activity (e.g., a reminder for an adult to floss his teeth when the user is sensed to be in his home at 10 p.m.). Furthermore, an embodiment may communicate based on heuristics, such as the popular reference to the palm of one's hand as a guide for portion size. Suggestions such as “Consider these alternatives to salt” or “Chop extra vegetables for tomorrow's snacks” accompanied by appealing, realistic images can guide people at the moment of meal preparation.

An embodiment delivers preemptive communications to help a user respond to challenging situations in more constructive ways. For example, instead of berating oneself for having blown a diet, reframing the event in situational terms helps curtail negative emotions and facilitates more adaptive behaviors. An example of this reframing is attributing a dietary lapse, such as eating fast food, not to a lack of willpower but to unpreparedness for a long car ride. The latter interpretation generates practical solutions, such as packing snacks, rather than self-recrimination. Furthermore, mining the user's calendar may indicate the user has no lunch plans for a coming Tuesday. This analysis prompts the application to communicate with the user (e.g., send a message) on Monday night at 8 p.m. to chop vegetables and prepare a lunch for Tuesday to prevent ill-advised fast food impulse eating on Tuesday. Thus, an embodiment integrates with calendars (e.g., calendars kept on Smartphones) and other tools to help people work around perceived logistical barriers.

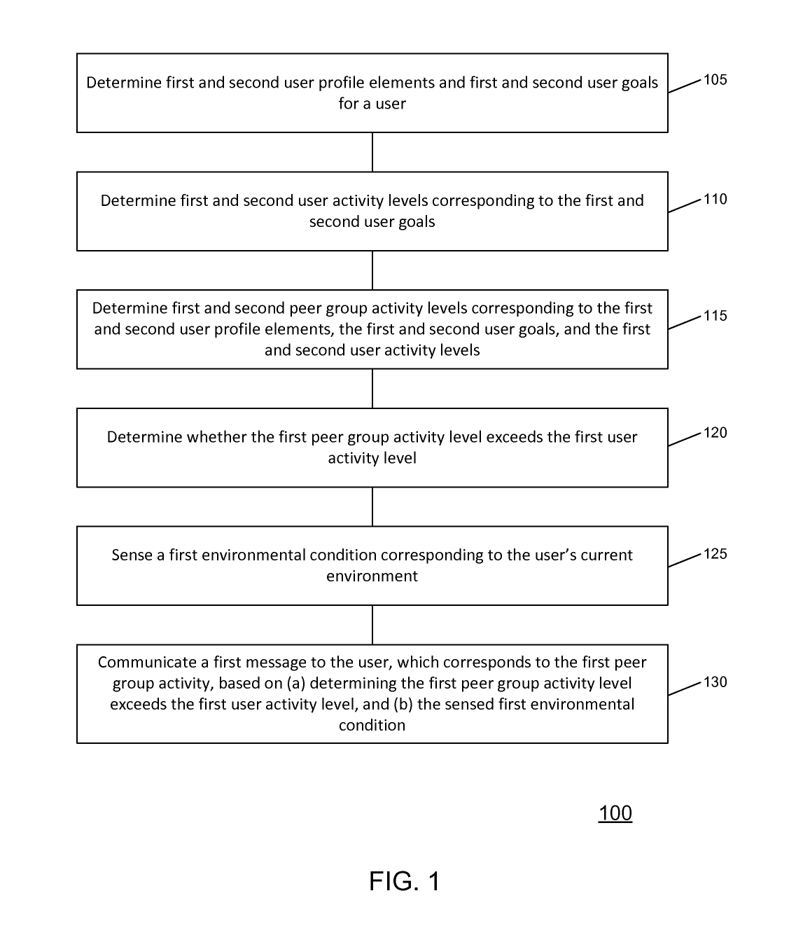

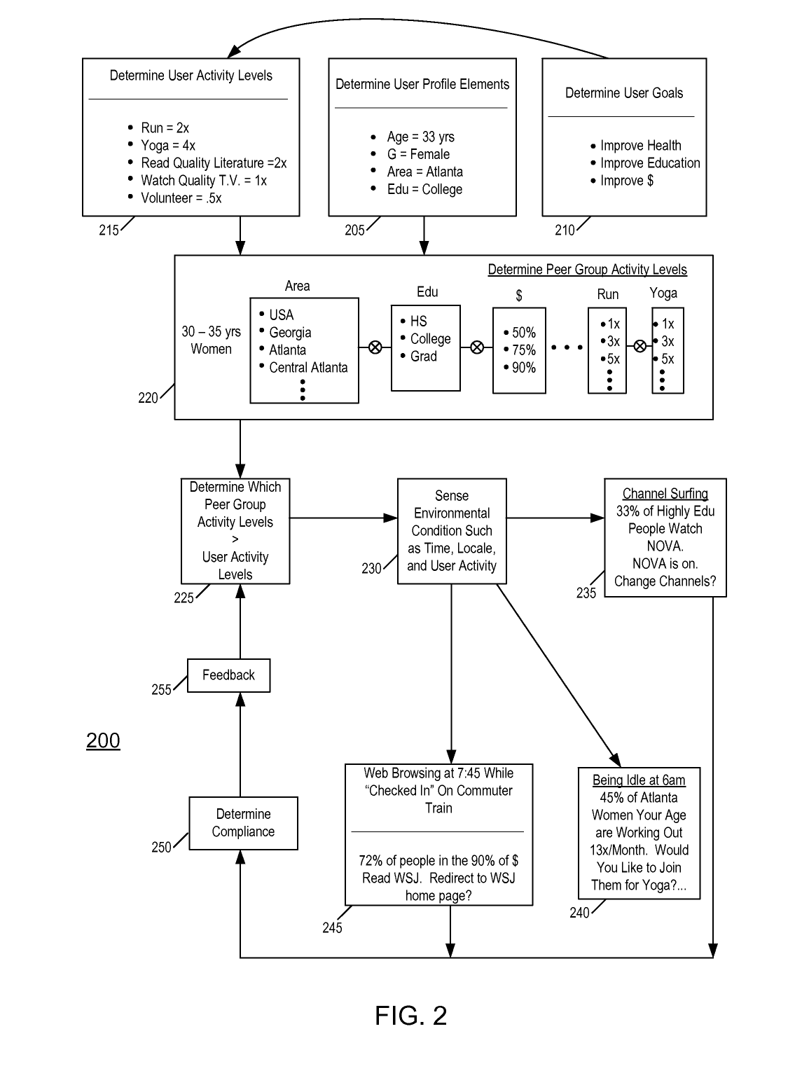

FIG. 1 includes a flow chart for a method 100 in an embodiment of the invention. FIG. 2 includes a flow chart regarding a specific example of the method of FIG. 1. The two figures are discussed below.

In block 105 hardware and/or software logic (distributed among various devices and modules or located within a single module or device, such as a Smartphone) may determine first and second user profile elements and first and second user goals for a user. In block 205 logic may implement various methods to determine user profile elements. For example, logic may data mine social media profiles for the user, such as those found on Facebook® and/or LinkedIn®, to determine profile elements such as user age (33 years old), gender (female), area of domicile (Central Atlanta, Ga., U.S.A.), education level (bachelors degree), and the like.

Logic may further data mine information related to the user to determine potential user goals. For example, in block 210 logic analyzes the user's recent web search terms and/or visited web sites, which in this particular example reveal an interest in (a) gyms, (b) attending graduate school to earn an advanced education degree, and (c) financial “self help” sites to help the user better manage her finances, accumulate wealth, and emerge from debt. This information may indicate interests in goals respectively related to improving the user's health, education, and finances.

In block 110 logic determines first and second user activity levels corresponding to the first and second user goals. As noted above, the user's goals may relate to improving health (interest in gyms), education (interest in graduate school), and finances (self help for finances). Accordingly, the logic may analyze the user's digital environment to assess the user's baseline user activity levels that relate to these goals. For example, to determine health patterns, on-line jogging journals may be analyzed or social media footprints such as the user “checking in” via Facebook® at a gym, using Foursquare® (which shares a user's location with other users) to share the user's location at a yoga studio, and the like. This research may indicate a running level of 2 times/month (2×) based on “checking in” at a park nearby the user and a yoga participation level of 4 times/month (4×). Web browsing history and on-line book sales site purchasing history (e.g., Amazon® book sales) may indicate the user views quality literature approximately 2 times/month (2×) whereas the majority of web sites visited are not determined to be educational. Further, television viewing history may be mined based on search history on on-line video viewing sites (e.g., Hulu®), recording patterns on digital video recorders (DVRs), whether those recorded shows were actually viewed, and the like. Based on such activity logic may determine the user watches quality programming approximately 1 time/month (1×). Furthermore, the logic may proactively determine other patterns not called for by determined user goals, such as the user's volunteering patterns. For example, based on Facebook® posts and calendar entries, the user may volunteer approximately 0.5 times/month (0.5×). Also, if no determinative or reliable information regarding a goal is found then a tentative 0 times/month (0×) may be noted.

In block 115 logic determines first and second peer group activity levels corresponding to the first and second user profile elements, the first and second user goals, and the first and second user activity levels. For example, in block 220 the user is known to be in the 30-35 year old female demographic. Accordingly, based on data mining of online social science literature, databases, other user's acquired data using embodiments discussed herein, peer group activity levels may be determined for 30-35 year old females in the U.S.A., the state of Georgia, the city of Atlanta, the central portion of Atlanta, a specific apartment complex or dormitory within central Atlanta, and the like. For these target individuals data may be determined for education levels (e.g., high school or primary education, a college degree or second education, and a graduate degree), economic status gleaned from purchases habits, residence, job listed on LinkedIn® profiles (e.g., top 50%, 75%, 90% of average family income within U.S.A.), yoga practice (1×, 3×, 5×), running patterns (1×, 3×, 5×), quality literature reading patterns (1×, 3×, 5×), quality television programming habits (1×, 3×, 5×), volunteerism (1×, 3×, 5×), and the like (not all of which are illustrated in FIG. 2 for purposes of clarity). This data may be used to find a peer group that the user most readily identifies with and that will motivate the user to attain goals (as explained below).

In one embodiment, the peer group may be selected from a group formally linked to the user. For example, the peer group may be taken from the user's contacts of Facebook® “friends”, and the like.

In block 120 logic determines whether the first peer group activity level exceeds the first user activity level. For example, in block 225 logic may generate many combinations of potential peer group activity levels such as the yoga habits of 30-35 year old U.S. females living in the U.S.A., as well as those living in Georgia, Atlanta, Central Atlanta, and the user's particular apartment complex in which she lives. The same analysis can be conducted for peer group running, reading, and content viewing (e.g., TV) habits. The above information can be cross-referenced by peer education level, financial status, and the like. If one potential peer group shows 30-35 year old females living in the U.S.A. and Georgia do not practice yoga more than 2×, then the logic may elect to not motivate the user with this data (based on the concept that user will not be motivated to do more yoga is she believes she already does more than her peers). However, if the logic determines 30-35 year old females living in Central Atlanta practice yoga 8× (i.e., twice as often as the user) then a corresponding message may help motivate the user toward her identified goal of improving health (see block 210). This will be discussed further below with regard to block 130.

Before discussing block 130, in block 125 logic may sense a first environmental condition corresponding to the user's current environment. Such a condition may be the time and/or day of the week, the geographic location of the user (based on Global Positioning System (GPS) readings) such as whether she is at home or work, and/or the activity level of the user (based on GPS and/or accelerometer readings). For example regarding activity level, the sensed condition may indicate a user is jogging or cycling based on rate of speed, gait analysis, or even social media (e.g., checking in at a gym).

In block 130 logic communicates a first message to the user, which corresponds to the first peer group activity, based on (a) determining the first peer group activity level exceeds the first user activity level, and (b) the sensed first environmental condition. For example, in block 235 logic may determine the user is stationary (i.e., environmental condition=activity level), at her home (i.e., environmental condition=location), and advancing through television shows or searching through potential program listings (i.e., environmental condition=activity). At this time the user may be highly tempted to act in a manner inconsistent with her goal of improving her education level (see block 210). Thus, the logic may communicate a message to the user (e.g., Short Message Service (SMS) text, e-mail, social media post, audio conveyed via Smartphone, and the like) including a reminder to the user of her goal to improve her education. The communication may concern a quality program such as science-related “NOVA” or any other such content, show, or programming. The communication may provide suggestions such as “33% of Highly Educated women in Central Atlanta watch NOVA. You have one episode of NOVA recorded and another broadcast of the show is available on channel 8. Would you like to tune to channel 8?” This message is sent to the user because in block 225 this demographic watches more quality programming than does the user. Thus, this demographic may help motivate the user to attain her goal of improving her education. Other examples are provided in blocks 240 and 245. Block 240 relies on block 230 determining, for example, the user is idle (i.e., environmental condition=activity level) at 6 a.m. on Monday morning (i.e., environmental condition=time) at her residence (e.g., environmental condition=location). Based on the user's goal to improve her health, the message may include “45% of Atlanta women your age are working out 13 times/month. Would you like to join them for Yoga? A class starts at 6:30 a.m. only two blocks from here.” Block 230 may sense a user is browsing the web at 7:45 a.m. while “checked in” (via social media) on a commuter train on a Monday morning. Such a sensed environmental condition may lead to the logic generating a message such as “72% of people in the 90% of earners read the Wall Street Journal®. Click here to redirect your browser to the Wall Street Journal® website.”

An embodiment may include a feedback mechanism. The logic may determine the user compliance with messages based on responses from the user. For example, a graphical user interface (GUI) may allow a user to vote on messages corresponding to blocks 235, 240, 245. The voting may include a user voting “like” or “dislike” to the message (block 250). The user response may be indirect such as “checking in” for yoga shortly after the message of block 240 (which indicates compliance with the message). An accelerometer reading that the user is doing any form of exercise (e.g., running, riding a stationary bike) within 30 minutes of the message of block 240 may be deemed compliance. Then, an embodiment may again detect idleness at 6 a.m. but based on prior feedback analysis indicating the user rarely complies with invitations for exercise early in the morning (block 255) may instead opt to prompt the user at 6 p.m. in search of higher compliance (based on the idea that the user may prefer exercising in the evening). Further, an option to go jogging may replace the invitation for yoga based on previous poor compliance with invitations to participate in yoga. If further compliance is still not attained, the feedback may indicate the goal is not an actual goal for the user and that a correction to the analysis of block 210 is needed. For example, early analysis may have interpreted web searches for “yoga studio” to mean the user wished to increase her health but actually, she was just looking to buy a gift certificate for her mother to participate in yoga. Messaging may then focus more on improving education or finances (other potential goals identified in block 210). Thus, in one embodiment upon sensing future environmental conditions the logic may communicate messages to the user, which correspond to one peer group activity, based on compliance (e.g., positive compliance); and determine to send no additional message to the user, which corresponds to another peer group activity, based on compliance (e.g., negative compliance).

An embodiment includes receiving a request from the user and denying the request for at least a portion of time based on the first user goal and the sensed first environmental condition. For example, the logic may determine the user has a goal of improving her health. Further, the logic may determine the user is presently located in a fast food restaurant (based on GPS determinations, social media “checking in”, and the like). The user may request the logic to provide funds for a purchase at the restaurant (e.g., using PayPal® on a Smartphone to buy a cheeseburger and fries). Based on the sensed context (user is at a fast food restaurant) and the goal (to gain better health) the logic may deny the request and refuse to grant funds for any purchase. The refusal may be temporary and may last only sixty seconds (long enough for the user to reconsider the choice that is inconsistent with her goals). The logic may offer a tip that a health food store is located only 25 meters from the user's present location and that the store has a lunch special on salads. The refusal may be overridden by the user. Overriding the refusal may prompt a message later that evening to prepare a sack lunch for tomorrow's lunch to avoid another impulse purchase of fast food. Thus, an embodiment gains insight about a user's history and choices based on a strong therapeutic alliance with the user. Whether the user requests an instant purchase or directions to the nearest cupcake shop (whereby alternative or additional directions to low fat yogurt stores could be provided), an embodiment may know that what we ask for is not always in our best interests.

Many other examples are possible although not specifically illustrated in FIG. 2. For example, upon detection that the user (whose potential goal includes improving his health and appearance) is stationary in his residence on a Saturday afternoon, the logic may detect ten of his social media contacts (e.g., Facebook® friends or even just contacts listed in an email service of his Smartphone) are playing soccer in a nearby park and invite the user to join them.

As another example, block 230 sensing an environmental condition is not limited to real time sensing but may include predictive sensing. Such predictive sensing may related to weather, traffic, and the like. For example, for a user interested in bettering his health and appearance, a Sunday evening message may include “Bicycle ridership to work for 30-40 year old males that live 3-5 miles from work increases 50% on days like tomorrow where the weather is forecast to be clear and above 75 degrees.”

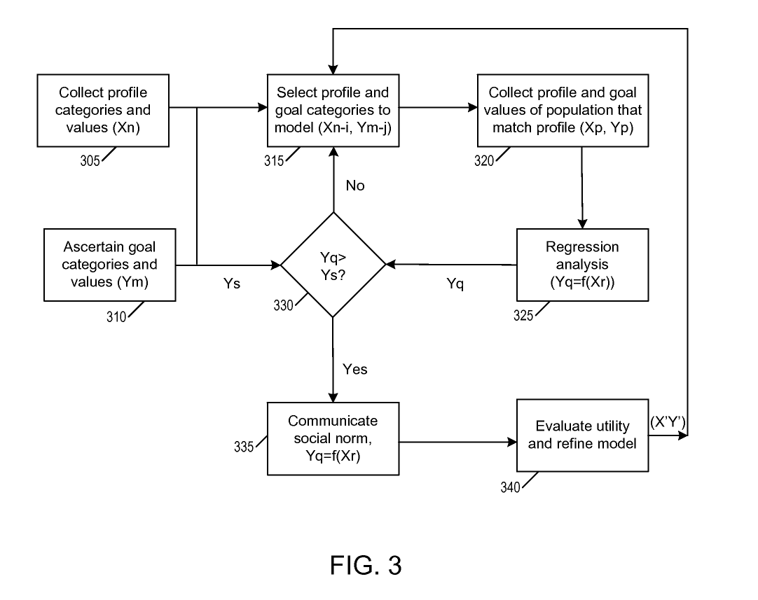

FIG. 3 includes a flow chart for a method 300 in an embodiment of the invention. In block 305 the logic collects profile categories Xn (e.g., age, gender, education, and locale) for a user. In block 310 the logic ascertains goal categories (e.g., yoga) and values (e.g., 3 times/month) Ym. In block 315 the logic selects profile and goal categories to model (Xn-i, Ym-j). This may include 30-35 year old women that want to improve their health. In block 320 the logic may collect profile and goal values corresponding to the profile and categories of block 315. This may include investigating the yoga patterns of 30-35 year old women with a high school diploma living in Atlanta and the yoga patterns of 30-35 year old women with graduate degrees living in Atlanta. Regression analysis may occur to make quantitative predictions of one variable from the values of another. In block 330 the logic determines whether the peer values (social norms) exceed the user values. If not the logic may return to block 315 to search for peer information that may be more motivational to the user. However, if the peer value exceeds the user value the social norm related to the value may be communicated to the user (block 335). In block 340 feedback (e.g., compliance determined via voting) is used to refine the process.

Thus, an embodiment includes creating persuasive digital messages by delivering them at appropriate times, including social norms and proximity of people within one's social network who are engaged in the relevant activity. This may include data mining for social norms in order to identify a set of statistics about the majority of a peer reference group performing the relevant behavior. Embodiments may require that their activity level/frequency be superior to that of the target individual (e.g., in the case of a message about the importance of volunteering, the referenced peer group should volunteer more than the individual). An embodiment may identify the individual's aspirations and related behaviors (e.g., weight loss—playing soccer for exercise, fluency in French—watching French films) from web browsers, search engines, on-line video suppliers or existing users profiles. Further, the embodiment may identify times that are relevant for contextual reminders of that activity (e.g., after school is a logical time to encourage high school students to exercise). The embodiment may associate desired behavior with status updates of an individual's peers (e.g., status updates on Facebook®). The embodiment may continually mine and summarize the related status updates. Then, at the times of day relevant for the activity, identify (e.g., via status updates and location awareness) nearby friends who are currently engaged in the goal activity (e.g., members of your peer group are playing soccer in a park 200 meters from you). The embodiment may present the message as an invitation following the more general social norm (e.g., “70% of parents in your city volunteer at least 2 hours a month at their children's schools. Eleven of your friends are at the auction for Jones Elementary School this afternoon at Thomas Hall (1.5 miles from you).”). Further, the embodiment may track whether the individual followed the suggestions and refine suggestions over time based on whether they are followed by user or liked by the user (e.g., using a thumbs up/thumbs down rating system).

For one embodiment data mining may include profiling of web browsers, search engines, and social media profile pages. The embodiment then mines for accurate motivating statistic based on profile elements (e.g., via web crawling). The embodiment may compare the norm/statistic to the user's current activity. If the norm is less desirable than user's behavior, the system rejects it and continues searching for a norm that outperforms the target user using other profile variables. Suggestion/motivation models may be refined through regression analysis (e.g., variables are weighted in terms of their power in predicting an effective social norm). The embodiment becomes more efficient in presenting norms over time, as it learns the preferences of an individual.

While various embodiments concern mobile computing devices such as Smartphones, tablets, notebooks, netbooks, and the like, embodiments are not so limited an may be used on mobile and non-mobile computing environments.

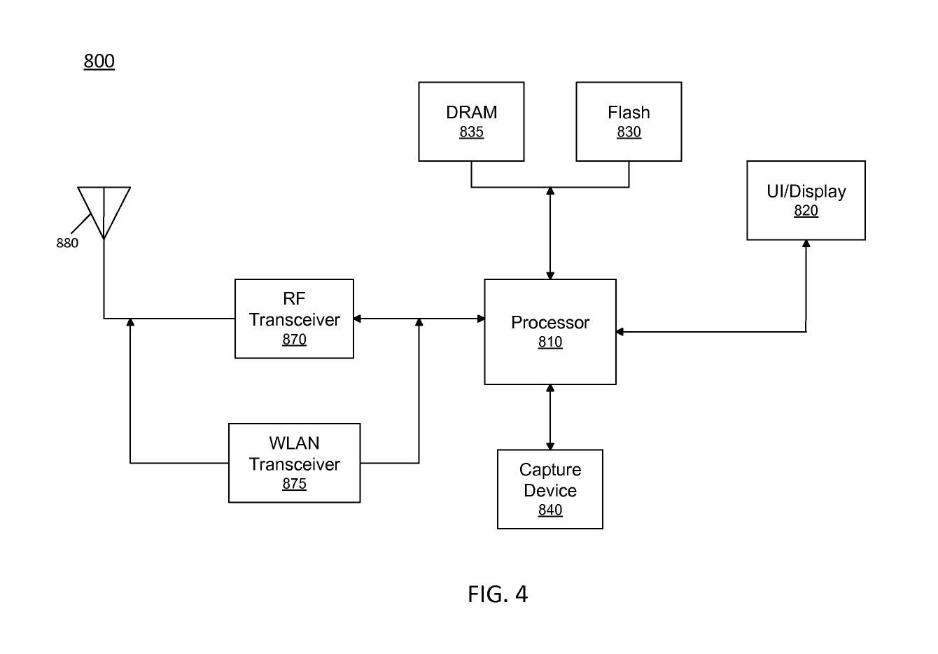

Embodiments can be used in many different environments. FIG. 4 includes a block diagram of an example system 800 with which embodiments, such as those described in cooperation with FIGS. 1, 2, and/or 3, can be used. System 800 may be a Smartphone, cell phone, mobile internet device, tablet, or other wireless communicator or computer node. System 800 may include at least one processor 810 (e.g., baseband processor, microprocessor, application processor, and the like). Processor 810 can perform various signal processing with regard to communications, as well as perform computing operations for the device. In turn, processor 810 can couple to a user interface/display 820 which can be realized in some embodiments by a touch screen display. In addition, processor 810 may couple to a memory system including non-volatile memory, such as flash memory 830 and/or a system memory such as dynamic random access memory (DRAM) 835. As further seen, processor 810 can further couple to a capture device 840 such as an image capture device that can record video and/or still images. To enable communications to be transmitted and received circuitry may be coupled between processor 810 and antenna 880. Specifically, radio frequency (RF) transceiver 870 and wireless local area network (WLAN) transceiver 875 may be present. In general, RF transceiver 870 may be used to receive and transmit wireless data and calls according to a given wireless communication protocol such as 3G or 4G wireless communication protocol such as in accordance with a code division multiple access (CDMA) global system for mobile communication (GSM), long term evolution (LTE) or other protocol. Other wireless communications such as receipt or transmission of radio signals (e.g., AM/FM), or global positioning satellite (GPS) signals may also be provided. In addition, via WLAN transceiver 875, local wireless signals, such as according to a Bluetooth® standard or an IEEE 802.11 standard such as IEEE 802.11a/b/g/n can also be realized. Although shown at this high level system depiction, understand the scope of the present invention is not limited in this regard.

Embodiments may be implemented in code and may be stored on at least one storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Embodiments of the invention may be described herein with reference to data such as instructions, functions, procedures, data structures, application programs, configuration settings, code, and the like. When the data is accessed by a machine, the machine may respond by performing tasks, defining abstract data types, establishing low-level hardware contexts, and/or performing other operations, as described in greater detail herein. The data may be stored in volatile and/or non-volatile data storage. The terms “code” or “program” cover a broad range of components and constructs, including applications, drivers, processes, routines, methods, modules, and subprograms and may refer to any collection of instructions which, when executed by a processing system, performs a desired operation or operations. In addition, alternative embodiments may include processes that use fewer than all of the disclosed operations, processes that use additional operations, processes that use the same operations in a different sequence, and processes in which the individual operations disclosed herein are combined, subdivided, or otherwise altered.

In one embodiment, use of the term control logic or logic includes hardware, such as transistors, registers, or other hardware, such as programmable logic devices. However, in another embodiment, logic also includes software or code. Such logic may be integrated with hardware, such as firmware or micro-code. A processor or controller may include control logic intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. The logic may be included in a module or distributed across various modules that may be located remotely from one another (e.g., cloud based computing).

An embodiment includes a method executed by at least one processor comprising: determining first and second user profile elements and first and second user goals for a user; determining first and second user activity levels corresponding to the first and second user goals; determining first and second peer group activity levels corresponding to the first and second user profile elements, the first and second user goals, and the first and second user activity levels; determining the first peer group activity level exceeds the first user activity level; sensing a first environmental condition corresponding to the user's current environment; and communicating a first message to the user, which corresponds to the first peer group activity, based on (a) determining the first peer group activity level exceeds the first user activity level, and (b) the sensed first environmental condition. Other embodiments do not require all of these elements. For example, an embodiment may include communicating a first message to the user, which corresponds to the first peer group activity, based on (a) determining the first peer group activity level exceeds the first user activity level, or (b) the sensed first environmental condition. Further, an embodiment may include determining first and second peer group activity levels corresponding to any one, but not all, of the first and second user profile elements, the first and second user goals, and the first and second user activity levels.

An embodiment may include determining the second peer group activity level exceeds the second user activity level; communicating a second message to the user, which corresponds to the second peer group activity, based on (a) determining the second peer group activity level exceeds the second user activity level, and (b) one of the sensed first environmental condition and another sensed environmental condition; determining the user's first compliance with the first message based on a first response from the user; and determining the user's second compliance with the second message based on a second response from the user.

An embodiment may comprise: sensing a second environmental condition for the user; communicating another message to the user, which corresponds to the first peer group activity, based on the sensed second environmental condition and the determined first user compliance; and determining to send no additional message to the user, which corresponds to the second peer group activity, based on the determined second user compliance.

An embodiment may comprise: determining whether the second peer group activity level exceeds the second user activity level; when the second peer group activity level exceeds the second user activity level, communicating a second message to the user that corresponds to the second peer group activity; and when the second peer group activity level does not exceed the second user activity level determining not to communicate the second message to the user.

In an embodiment sensing the first environmental condition is based on determining whether the user is in motion. In an embodiment, sensing the first environmental condition is based on determining a geographical location of the user.

An embodiment may include receiving a request from the user; and denying the request for at least a portion of time based on the first user goal. An embodiment may comprise receiving a request from the user; and denying the request for at least a portion of time based on the first user goal and the sensed first environmental condition. In an embodiment the request corresponds to a request for monetary funds.

In an embodiment determining one of the first user profile element and the first user goal is based on one of analyzing a web search previously conducted by the user and analyzing a web page previously visited by the user.

An embodiment may include at least one machine readable medium comprising a plurality of instructions that in response to being executed on a computing device, causes the computing device to carry out a method described above. An embodiment may include a communications device arranged to carry out a method described above. An embodiment may include means for performing any one of the methods described above.

An embodiment includes an apparatus comprising at least one memory and at least one processor, coupled to the at least one memory, to perform operations comprising: determining first and second user profile elements and first and second user goals for a user; determining first and second user activity levels corresponding to the first and second user goals; determining first and second peer group activity levels corresponding to at least one of the first and second user profile elements, the first and second user goals, and the first and second user activity levels; performing at least one of determining the first peer group activity level exceeds the first user activity level; and sensing a first environmental condition corresponding to the user's current environment; and communicating a first message to the user, which corresponds to the first peer group activity, based on at least one of (a) determining the first peer group activity level exceeds the first user activity level, and (b) the sensed first environmental condition.

An embodiment includes at least one processor is to perform operations comprising: determining the second peer group activity level exceeds the second user activity level; communicating a second message to the user, which corresponds to the second peer group activity, based on at least one of (a) determining the second peer group activity level exceeds the second user activity level, and (b) at least one of the sensed first environmental condition and another sensed environmental condition; determining the user's first compliance with the first message based on a first response from the user; and determining the user's second compliance with the second message based on a second response from the user.

An embodiment includes at least one processor is to perform operations comprising: sensing a second environmental condition for the user; communicating another message to the user, which corresponds to the first peer group activity, based on at least one of the sensed second environmental condition and the determined first user compliance; and determining to send no additional message to the user, which corresponds to the second peer group activity, based on the determined second user compliance.

An embodiment includes sensing the first environmental condition based on determining whether the user is in motion. An embodiment includes the at least one processor to perform operations comprising: receiving a request from the user; and denying the request for at least a portion of time based on the first user goal. An embodiment includes the at least one processor to perform operations comprising: receiving a request from the user; and denying the request for at least a portion of time based on the first user goal and the sensed first environmental condition.

An embodiment includes a computer system including the at least one processor of the above embodiments and further comprising at least one display (e.g., mobile computing devices such as Smartphones, tablets, notebooks, netbooks, personal digital assistants, and the like).

“Determining” a profile element may include receiving such an element into memory from a remotely located device. “Determining” does not necessarily mean “initially determining for the first time” and the like. For example, a separate application operated on a distant server may initially determine the “profile elements”, “goals”, “activity levels” and the like and then transmit that data to a mobile computing device that again “determines” the data based on, for example, receiving the data and storing the data within the computing device.

Furthermore, various embodiments discuss, for example, a peer group activity level that “exceeds” a user activity level. Exceeds is not limited to “greater than” or “less than”. For example, a peer group may consume two alcoholic drinks/week and a user may consume ten alcoholic drinks/week. If the perspective is that less alcohol consumption is a desirable goal then in this case the peer group “exceeds” the user activity level. In other words, a 1 to 10 rating system having “1” as most desirable and “10” as least desirable would mean that a 1 “exceeds” a 10 based on the perspective inherent to this system.

All optional features of apparatus(s) described above may also be implemented with respect to method(s) or process(es) described herein. While the present invention has been described with respect to a limited number of embodiments, those skilled in the art will appreciate numerous modifications and variations therefrom. It is intended that the appended claims cover all such modifications and variations as fall within the true spirit and scope of this present invention.

1. At least one machine readable medium comprising instructions that when executed on a computing device cause the computing device to perform a method comprising:
determining first and second user profile elements and first and second user goals for a user;
determining first and second user activity levels corresponding to the first and second user goals;
determining first and second peer group activity levels corresponding to the first and second user profile elements, the first and second user goals, and the first and second user activity levels;
determining the first peer group activity level exceeds the first user activity level;
sensing a first environmental condition corresponding to the user's current environment; and
communicating a first message to the user, which corresponds to the first peer group activity, based on (a) determining the first peer group activity level exceeds the first user activity level, and (b) the sensed first environmental condition.

2. The at least one medium of claim 1, the method comprising:
determining the second peer group activity level exceeds the second user activity level;
communicating a second message to the user, which corresponds to the second peer group activity, based on (a) determining the second peer group activity level exceeds the second user activity level, and (b) one of the sensed first environmental condition and another sensed environmental condition;
determining the user's first compliance with the first message based on a first response from the user; and
determining the user's second compliance with the second message based on a second response from the user.

3. The at least one medium of claim 2, the method comprising:
sensing a second environmental condition for the user;
communicating another message to the user, which corresponds to the first peer group activity, based on the sensed second environmental condition and the determined first user compliance; and
determining to send no additional message to the user, which corresponds to the second peer group activity, based on the determined second user compliance.

4. The the at least one medium of claim 1, the method comprising:
determining whether the second peer group activity level exceeds the second user activity level;
when the second peer group activity level exceeds the second user activity level, communicating a second message to the user that corresponds to the second peer group activity; and when the second peer group activity level does not exceed the second user activity level determining not to communicate the second message to the user.

5. The at least one medium of claim 1, wherein sensing the first environmental condition is based on determining whether the user is in motion.

6. The at least one medium of claim 5, wherein sensing the first environmental condition is based on determining a geographical location of the user.

7. The at least one medium of claim 1, the method comprising:
receiving a request from the user; and
denying the request for at least a portion of time based on the first user goal.

8. The at least one medium of claim 1, the method comprising:
receiving a request from the user; and
denying the request for at least a portion of time based on the first user goal and the sensed first environmental condition.

9. The at least one medium of claim 8, wherein the request corresponds to a request for monetary funds.

10. The at least one medium of claim 1, wherein determining one of the first user profile element and the first user goal is based on one of analyzing a web search previously conducted by the user and analyzing a web page previously visited by the user.

11. (canceled)

12. (canceled)

13. (canceled)

14. An apparatus comprising:
at least one memory and at least one processor, coupled to the at least one memory, to perform operations comprising:
determining first and second user profile elements and first and second user goals for a user;
determining first and second user activity levels corresponding to the first and second user goals;
determining first and second peer group activity levels corresponding to at least one of the first and second user profile elements, the first and second user goals, and the first and second user activity levels;
performing at least one of determining the first peer group activity level exceeds the first user activity level; and sensing a first environmental condition corresponding to the user's current environment; and
communicating a first message to the user, which corresponds to the first peer group activity, based on at least one of (a) determining the first peer group activity level exceeds the first user activity level, and (b) the sensed first environmental condition.

15. The apparatus of claim 14, wherein the at least one processor is to perform operations comprising:
communicating a second message to the user, which corresponds to the second peer group activity, based on at least one of (a) determining the second peer group activity level exceeds the second user activity level, and (b) at least one of the sensed first environmental condition and another sensed environmental condition;
determining the user's first compliance with the first message based on a first response from the user; and
determining the user's second compliance with the second message based on a second response from the user.

16. The apparatus of claim 15, wherein the at least one processor is to perform operations comprising:
sensing a second environmental condition for the user;
communicating another message to the user, which corresponds to the first peer group activity, based on at least one of the sensed second environmental condition and the determined first user compliance; and
determining to send no additional message to the user, which corresponds to the second peer group activity, based on the determined second user compliance.

17. The apparatus of claim 14, wherein sensing the first environmental condition is based on determining whether the user is in motion.

18. The apparatus of claim 14, wherein the at least one processor is to perform operations comprising:
receiving a request from the user; and
denying the request for at least a portion of time based on the first user goal.

19. The apparatus of claim 14, wherein the at least one processor is to perform operations comprising:
receiving a request from the user; and
denying the request for at least a portion of time based on the first user goal and the sensed first environmental condition.

20. (canceled)

21. The apparatus of claim 14, wherein sensing the first environmental condition is based on determining at least one a geographical location of the user and whether the user is in motion.

22. A method executed by at least one processor comprising:
determining first and second user profile elements and first and second user goals for a user;
determining first and second user activity levels corresponding to the first and second user goals;
determining first and second peer group activity levels corresponding to the first and second user profile elements, the first and second user goals, and the first and second user activity levels;
determining the first peer group activity level exceeds the first user activity level;
sensing a first environmental condition corresponding to the user's current environment; and
communicating a first message to the user, which corresponds to the first peer group activity, based on (a) determining the first peer group activity level exceeds the first user activity level, and (b) the sensed first environmental condition.

23. The method of claim 22 comprising:
determining the second peer group activity level exceeds the second user activity level;
communicating a second message to the user, which corresponds to the second peer group activity, based on (a) determining the second peer group activity level exceeds the second user activity level, and (b) one of the sensed first environmental condition and another sensed environmental condition;
determining the user's first compliance with the first message based on a first response from the user; and
determining the user's second compliance with the second message based on a second response from the user.

24. The method of claim 22 comprising:
receiving a request from the user; and
denying the request for at least a portion of time based on the first user goal.
